(19) United States
(12) Patent Application Publication
(10) Pub. No.: US 2026/0245519 A1
(43) Pub. Date: Aug. 20, 2026

(54) PIXEL CIRCUIT, A DRIVING METHOD THEREOF, AND A DISPLAY PANEL

(71) Applicants: Hefei Visionox Technology Co., Ltd., Hefei (CN); Kunshan Govisionox Optoelectronics Co., Ltd., Kunshan (CN)

(72) Inventors: Xiaoxiao GUO, Kunshan (CN); Lu ZHANG, Kunshan (CN); Zhenshen PAN, Kunshan (CN)

(73) Assignees: Hefei Visionox Technology Co., Ltd., Hefei (CN); Kunshan Govisionox Optoelectronics Co., Ltd., Kunshan (CN)

(21) Appl. No.: 19/643,836

(22) Filed: Apr. 10, 2026

Related U.S. Application Data
(63) Continuation of application No. PCT/CN2024/097449, filed on Jun. 5, 2024.

(30) Foreign Application Priority Data
Aug. 10, 2023 (CN) 202311018212.8

(51) Int. Cl. G09G 3/3233

(52) U.S. Cl. CPC G09G 3/3233; G09G 2300/043; G09G 2300/0819; G09G 2310/08; G09G 2320/0233; G09G 2320/0247

(57) ABSTRACT

A pixel circuit includes a driving module, a first initialization module, and a light emitting device; the first initialization module is electrically connected to a second terminal of the driving module, the first initialization module is configured to transmit a third initialization voltage to a first terminal and the second terminal of the driving module in a third initialization phase; the light emitting device is connected between the second terminal of the driving module and a second power supply; the driving module is configured to generate a driving current to drive the light emitting device to emit light according to a voltage at a control terminal of the driving module.

### CROSS-REFERENCE TO RELATED APPLICATION

This is a continuation of International Patent Application NO. PCT/CN2024/097449, filed on June 5, 2024, which claims priority to a Chinese Patent Application No. CN 202311018212.8 filed on August 10, 2023, the disclosure of which is incorporated herein by reference in its entirety.

### FIELD

The present application relates to the field of display technology, in an embodiment, relates to a pixel circuit, a driving method thereof, and a display panel.

### BACKGROUND

An Organic Light Emitting Diode (OLED) display panel has characteristics of a high contrast, a thin thickness, a wide viewing angle, a fast response speed and a low power consumption, and has been increasingly applied to multiple display fields. However, a display panel has a problem of a low frequency flicker under a low frequency driving, which affects a display effect of the display panel.

### SUMMARY

The present application provides a pixel circuit, a driving method thereof, and a display panel, improving a low frequency low gray scale flicker problem of a display panel, and improving a display effect of the display panel.

According to one embodiment of the present application, there is provided a pixel circuit, including a driving module, a first initialization module, and a light emitting device;

the first initialization module is electrically connected to a second terminal of the driving module, the first initialization module is configured to transmit a third initialization voltage to a first terminal and the second terminal of the driving module in a third initialization phase;

the light emitting device is connected between the second terminal of the driving module and a second power supply; the driving module is configured to generate a driving current to drive the light emitting device to emit light according to a voltage at a control terminal of the driving module.

According to another embodiment of the present application, there is provided a driving method for a pixel circuit, applied to the pixel circuit of any embodiment of the present application, including

in the third initialization phase, controlling the first initialization module to be turned on, transmitting the third initialization voltage to the first terminal and the second terminal of the driving module.

According to another embodiment of the present application, there is provided a display panel, including the pixel circuit of any embodiment of the present application.

An embodiment of the present application discloses, in the pixel circuit, a driving module, a first initialization module, and a light emitting device are provided; the first initialization module is electrically connected to the second terminal of the driving module; in a data writing frame (a refresh frame), the third initialization voltage may be transmitted to the first terminal and the second terminal of the driving module through the first initialization module in the third initialization phase; such that a bias state of a driving transistor included in the driving module does not differ too much between the data writing frame and a holding frame, thereby improving the low frequency low gray scale flicker problem of the display panel and improving the display effect of the display panel.

### BRIEF DESCRIPTION OF THE DRAWINGS

FIG. 1 is a structural diagram of a pixel circuit provided by an embodiment of the present application;

FIG. 2 is a structural diagram of another pixel circuit provided by an embodiment of the present application;

FIG. 3 is a circuit diagram of a pixel circuit provided by an embodiment of the present application;

FIG. 4 is a timing diagram of a data writing frame of a pixel circuit provided by an embodiment of the present application;

FIG. 5 is a timing diagram of a holding frame of a pixel circuit provided by an embodiment of the present application;

FIG. 6 is a circuit diagram of another pixel circuit provided by an embodiment of the present application;

FIG. 7 is a cross-sectional view of a dual-gate transistor provided by an embodiment of the present application;

FIG. 8 is a circuit diagram of another pixel circuit provided by an embodiment of the present application;

FIG. 9 is a flowchart of a driving method for a pixel circuit provided by an embodiment of the present application;

FIG. 10 is a flowchart of another driving method for a pixel circuit provided by an embodiment of the present application; and

FIG. 11 is a structural diagram of a display panel provided by an embodiment of the present application.

### DETAILED DESCRIPTION

The terms "first", "second", etc. in the specification and the claims of the present application and the above drawings are used to distinguish similar objects, and are not necessarily used to describe a specific order or a sequence. The data used in this way may be interchangeable under appropriate circumstances so that the embodiments of the present application described herein can be implemented in orders other than those illustrated or described herein. Furthermore, the terms "comprising" and "having" and any variations thereof are intended to cover non-exclusive inclusions, in an embodiment, a process, a method, a system, a product or a device that includes a series of steps or units is not necessarily limited to those listed steps or units, but may include other steps or units not listed or inherent to these processes, methods, products or devices.

What has a greater impact on a display effect of an Active-Matrix Organic Light Emitting Diode (AMOLED) display panel is a working state of a driving transistor in a pixel circuit, in an embodiment, in a "7T1C" pixel circuit. In a "7T1C" pixel circuit, since a potential of the driving transistor cannot remain stable for a long time, a gate-source potential of the driving transistor is different under a data writing frame and a holding frame state, making a bias state of the driving transistor different, resulting in a different brightness of a data writing frame and a holding frame during a low frequency driving, causing a low frequency low gray scale display problem. The data writing frame can be understood as a refresh frame, and in each refresh frame, a control terminal of a driving module needs to perform one data voltage writing. When a display panel displays a high refresh rate display picture, a number of times a data voltage is written to the control terminal of the driving module in the pixel circuit within a same time is greater than a number of times the data voltage is written to the control terminal of the driving module in the pixel circuit when the display panel displays a low refresh rate display picture. That is, within the same time, a number of data writing frames when displaying a high refresh rate picture is greater than a number of data writing frames when displaying a low refresh rate picture.

In a related technology, in a data writing frame, a Vth (Vth is a threshold voltage of a driving transistor) negative bias of the driving transistor is large, while in a holding frame, the Vth negative bias is small, therefore in the holding frame, the threshold voltage of the driving transistor will be greater than the threshold voltage of the driving transistor in the data writing frame, thereby generating a frequency switching flicker. Taking an example of a display refresh frequency switching from 120Hz to 10Hz, when the display refresh frequency is 120Hz, a data writing is performed in each frame time, controlling the Vth negative bias, while when the display refresh frequency is 10Hz, the Vth is negatively biased in a refresh frame, while the Vth tends to be stable in the holding frame. Such that the bias state of the driving transistor is different, resulting in a different brightness of the data writing frame and the holding frame during the low frequency driving, causing the low frequency low gray scale display problem.

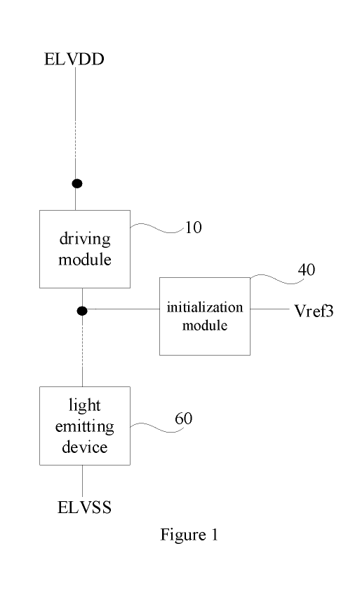

In view of this, an embodiment of the present application provides a pixel circuit. FIG. 1 is a structural diagram of a pixel circuit provided by an embodiment of the present application. Referring to FIG. 1, the pixel circuit comprises: a driving module 10, a first initialization module 40, and a light emitting device 60.

The first initialization module 40 is electrically connected to a second terminal of the driving module 10, the first initialization module 40 is configured to transmit a third initialization voltage Vref3 to a first terminal and the second terminal of the driving module 10 in a third initialization phase; the light emitting device 60 is connected between the second terminal of the driving module 10 and a second power supply; the driving module 10 is configured to generate a driving current to drive the light emitting device 60 to emit light according to a voltage at a control terminal of the driving module 10.

A refresh period of the pixel circuit (in an embodiment, each refresh period in at least one refresh period) comprises a data writing frame and a holding frame. The data writing frame and the holding frame are both provided with a third initialization phase. In an embodiment, the data writing frame may include a third initialization phase. In the third initialization phase, the first initialization module 40 is controlled to be turned on, and through a cooperation of the first initialization module 40 and the driving module 10, the third initialization voltage Vref3 is input to the second terminal of the driving module 10 and the first terminal of the driving module 10. In the holding frame, before a holding emission phase, a resetting of a potential at the first terminal of the driving module 10 and a potential at the second terminal of the driving module 10 is also performed, so that a bias state of a driving transistor included in the driving module 10 in the data writing frame does not differ greatly from a bias state of the driving transistor included in the driving module 10 in the holding frame, to improve the problem of a different brightness of the data writing frame and the holding frame during a low frequency driving, causing a low frequency low gray scale display problem.

The pixel circuit provided by the embodiment of the present application comprises a driving module 10, a first initialization module 40, and a light emitting device 60; the first initialization module 40 is electrically connected to the second terminal of the driving module 10; in a data writing frame (a refresh frame), a third initialization voltage is transmitted to the first terminal and the second terminal of the driving module 10 through the first initialization module 40 in the third initialization phase; such that the bias state of the driving transistor included in the driving module 10 does not differ too much between the data writing frame and the holding frame, thereby improving a low frequency low gray scale flicker problem of the display panel and improving a display effect of the display panel.

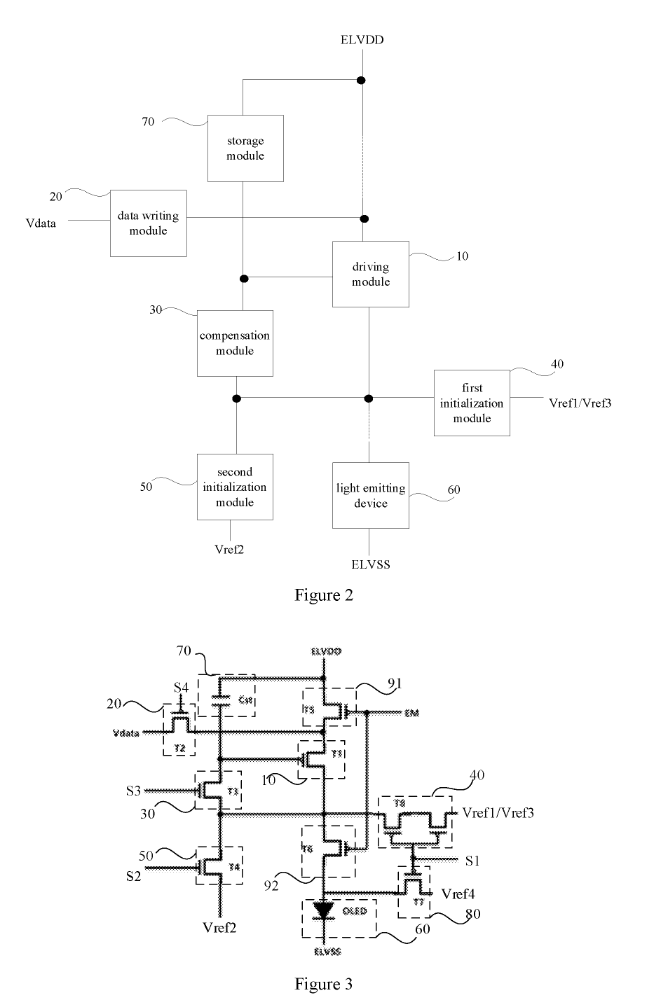

FIG. 2 is a structural diagram of another pixel circuit provided by an embodiment of the present application. Referring to FIG. 2, the pixel circuit further comprises: a data writing module 20, a compensation module 30, and a second initialization module 50;

the compensation module 30 is connected between a control terminal and a second terminal of the driving module 10; the second initialization module 50 is electrically connected to the second terminal of the driving module 10;

the first initialization module 40 is configured to transmit a first initialization voltage Vref1 to the second terminal of the driving module 10 in a first initialization phase, and transmit the first initialization voltage Vref1 to the control terminal of the driving module 10 through the compensation module 30;

the second initialization module 50 is configured to transmit a second initialization voltage Vref2 to the control terminal of the driving module 10 through the compensation module 30 in a second initialization phase;

the data writing module 20 is electrically connected to a first terminal of the driving module 10; the data writing module 20 is independently controlled, the data writing module 20 is configured to input a data voltage Vdata to the first terminal of the driving module 10 in a data writing phase;

the compensation module 30 is configured to perform a threshold voltage compensation on the driving module 10 in a threshold compensation phase.

In an embodiment, the threshold compensation phase may overlap with the data writing phase, in an embodiment, coincide.

The first initialization module 40 is further configured to transmit a third initialization voltage Vref3 to the first terminal and the second terminal of the driving module 10 in a third initialization phase.

The second initialization module 50 is configured to transmit the second initialization voltage Vref2 to the second terminal and the first terminal of the driving module 10 in the second initialization phase.

In an embodiment, the data writing frame may include a first initialization phase, a second initialization phase, a data writing phase, and a third initialization phase that are sequentially set. In the first initialization phase, the first initialization module 40 is controlled to be turned on, and the first initialization voltage Vref1 may be transmitted to the second terminal of the driving module 10; by cooperatively controlling a turn-on of the compensation module 30, the first initialization voltage Vref1 may be written to the control terminal of the driving module 10, to improve a hysteresis phenomenon of a driving transistor included in the driving module 10. In this phase, the driving module 10 may be turned off. The first initialization voltage Vref1 may be a positive voltage, in an embodiment, 5V. In this phase, the data writing module 20 may be turned off. In this phase, the second initialization module 50 may be turned off.

In the second initialization phase, the second initialization module 50 and the compensation module 30 are turned on, transmitting the second initialization voltage Vref2 to the control terminal of the driving module 10, and initializing a potential of the control terminal of the driving module 10 through the second initialization voltage Vref2, to perform a writing of the data voltage Vdata in the data writing phase. The first initialization voltage Vref1 and the second initialization voltage Vref2 may have opposite polarities. The second initialization voltage Vref2 may be -5V. In this phase, the driving module 10 may be turned on. Through the second initialization voltage Vref2, a potential of the second terminal of the driving module 10 and a potential of the first terminal of the driving module 10 are initialized. In this phase, the first initialization module 40 may be turned off. In this phase, the data writing module 20 may be turned off.

In the data writing phase, the data writing module 20 and the compensation module 30 are controlled to be turned on, and at this time, the control terminal of the driving module 10 is under a control of the second initialization voltage Vref2, the driving module 10 may be in a conducting state, so that the data voltage Vdata provided by a data voltage terminal passes through the data writing module 20, the driving module 10, and the compensation module 30 in sequence, to charge the control terminal of the driving module 10 until the driving module 10 is turned off. At this time, a potential of the control terminal of the driving module 10 is Vdata+Vth, to perform the threshold voltage compensation, and Vth is a threshold voltage of a driving transistor included in the driving module 10. The pixel circuit further comprises a storage module 70, the storage module 70 is connected to the control terminal of the driving module 10, the storage module 70 is configured to store the voltage of the control terminal of the driving module 10. The storage module 70 is connected between the control terminal of the driving module 10 and a first power supply. The data writing module 20 is independently controlled, which can avoid sharing a control signal with other modules and affecting a compensation effect on the potential of the control terminal of the driving module 10, and can improve the display effect of the display panel. A number of times the data writing module 20 is turned on in the data writing frame may be once, which, compared to a solution where the number of times the data writing module 20 is turned on in the data writing frame is at least twice, can reduce a load and improve an effect of a data writing and the threshold compensation. In this phase, the first initialization module 40 may be turned off. In this phase, the second initialization module 50 may be turned off.

In the third initialization phase, the first initialization module 40 is controlled to be turned on, and the compensation module 30 is controlled to be turned off. Through the cooperation of the first initialization module 40 and the driving module 10, the third initialization voltage Vref3 is input to the second terminal of the driving module 10 and the first terminal of the driving module 10. In this phase, the driving module 10 is turned on. In this phase, the data writing module 20 may be turned off. In this phase, the second initialization module 50 may be turned off. In the holding frame, before the holding emission phase, in the third initialization phase of the holding frame, the resetting of the potential of the first terminal of the driving module 10 and the potential of the second terminal of the driving module 10 is also performed, so that the bias state of the driving transistor included in the driving module 10 in the data writing frame does not differ greatly from the bias state of the driving transistor included in the driving module 10 in the holding frame, to improve the problem of the different brightness of the data writing frame and the holding frame during the low frequency driving, causing the low frequency low gray scale display problem.

The first initialization module 40 is electrically connected to the second terminal of the driving module 10, the compensation module 30 is connected between the control terminal and the second terminal of the driving module 10; the second initialization module 50 is electrically connected to the second terminal of the driving module 10; in a refresh frame, the first initialization voltage Vref1 can be transmitted to the second terminal and the control terminal of the driving module 10 through the first initialization module 40 in the first initialization phase, to reset potentials of the second terminal and the control terminal of the driving module 10; the second initialization voltage Vref2 is transmitted to the control terminal of the driving module 10 through the second initialization module 50 in the second initialization phase; after the data voltage Vdata is input to the control terminal of the driving module 10 through the data writing module 20 in the data writing phase; the third initialization voltage Vref3 is transmitted to the first terminal and the second terminal of the driving module 10 through the first initialization module 40 in the third initialization phase; such that the bias state of the driving transistor included in the driving module 10 does not differ too much between the data writing frame and the holding frame, thereby improving the low frequency low gray scale flicker problem of the display panel and improving the display effect of the display panel. In addition, the data writing module 20 provided in the pixel circuit is independently controlled, which can avoid sharing the control signal with other modules and affecting the compensation effect on the potential of the control terminal of the driving module 10, and improves the display effect of the display panel.

In one embodiment of the present application, in an embodiment, the first initialization voltage Vref1 is the same as the third initialization voltage Vref3. Setting the first initialization voltage Vref1 to be the same as the third initialization voltage Vref3 can simplify a control of a voltage of a first initialization voltage terminal.

In one embodiment of the present application, in an embodiment, the second initialization voltage Vref2 is different from the third initialization voltage Vref3. The first initialization voltage Vref1 and the third initialization voltage Vref3 can be a positive value, and the second initialization voltage Vref2 can be a negative value. In an embodiment, in the first initialization phase, the first initialization module 40 and the compensation module 30 are turned on, transmitting the first initialization voltage Vref1 of 5V to the second terminal and the control terminal of the driving module 10. In the second initialization phase, the second initialization module 50 and the compensation module 30 are turned on, and the first initialization module 40 is turned off; the second initialization voltage Vref2 of -5V is transmitted to the control terminal of the driving module 10. In the data writing phase, the second initialization module 50 is turned off, and the data writing module 20 and the compensation module 30 are turned on, writing the data voltage Vdata to the control terminal of the driving module 10 and performing the threshold voltage compensation. In the third initialization phase, the second initialization module 50, the data writing module 20, and the compensation module 30 are turned off, and the first initialization module 40 is turned on, transmitting the third initialization voltage Vref3 of 5V to the second terminal and the first terminal of the driving module 10, and in this phase the driving module 10 is turned on.

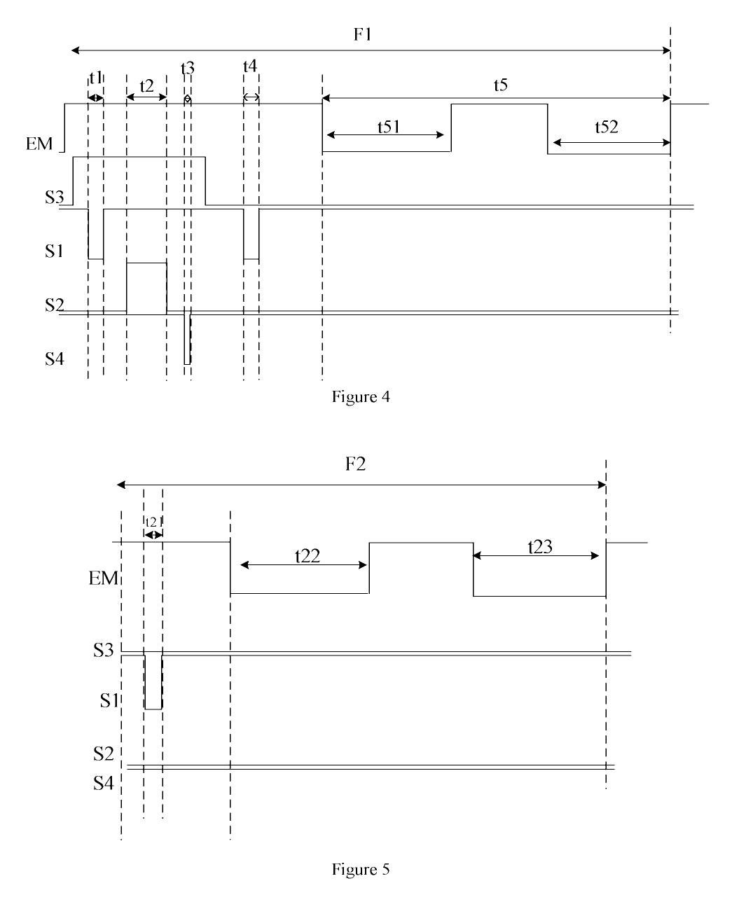

FIG. 3 is a circuit diagram of a pixel circuit provided by an embodiment of the present application, and FIG. 4 is a timing diagram of a data writing frame of a pixel circuit provided by an embodiment of the present application. Referring to FIGS. 3-4, the driving module 10 comprises a driving transistor T1; the data writing module 20 comprises a data writing transistor T2, controlled by a fourth scanning signal S4 for a conduction state; the compensation module 30 comprises a compensation transistor T3, controlled by a third scanning signal S3 for a conduction state; the first initialization module 40 comprises a first initialization transistor T8, controlled by a first scanning signal S1 for a conduction state; the second initialization module 50 comprises a second initialization transistor T4, controlled by a second scanning signal S2 for a conduction state; the light emitting device 60 is an OLED light emitting device; the storage module 70 comprises a storage capacitor Cst. The transistors used in the embodiments of the present application may all be thin film transistors or field effect transistors or other devices with same characteristics. The transistors T1 to T8 may all be P-type transistors. The transistors T1 to T8 may all be N-type transistors. Some of the transistors T1 to T8 are P-type transistors, and the rest are N-type transistors.

The data writing frame F1 comprises a first initialization phase t1, a second initialization phase t2, a data writing phase t3, and a third initialization phase t4 that are sequentially set.

In the first initialization phase t1, the compensation transistor T3 is controlled to be turned on through the third scanning signal S3, and the first initialization transistor T8 is controlled to be turned on through the first scanning signal S1, thereby transmitting the first initialization voltage Vref1 to a second electrode, a first electrode, and a gate of the driving transistor T1. This can improve the hysteresis phenomenon of the driving transistor T1 included in the driving module 10. The data writing transistor T2 is controlled to be turned off through the fourth scanning signal S4, and the second initialization transistor T4 is controlled to be turned off through the second scanning signal S2. In FIG. 3, it is in an embodiment shown that the compensation transistor T3 is turned on when the third scanning signal S3 is at a high level; the first initialization transistor T8 is turned on when the first scanning signal S1 is at a low level. The data writing transistor T2 is turned off when the fourth scanning signal S4 is at a high level; the second initialization transistor T4 is turned off when the second scanning signal S2 is at a low level.

In the second initialization phase t2, the compensation transistor T3 is controlled to be turned on through the third scanning signal S3, and the second initialization transistor T4 is controlled to be turned on through the second scanning signal S2, thereby transmitting the second initialization voltage Vref2 to the gate of the driving transistor T1. A potential of the gate of the driving transistor T1 is initialized through the second initialization voltage Vref2, to facilitate the writing of the data voltage Vdata in the data writing phase t3. The data writing transistor T2 is controlled to be turned off through the fourth scanning signal S4, and the first initialization transistor T8 is controlled to be turned off through the first scanning signal S1. In FIG. 3, it is in an embodiment shown that the second initialization transistor T4 is turned on when the second scanning signal S2 is at a high level.

In the data writing phase t3, the data writing transistor T2 is controlled to be turned on through the fourth scanning signal S4, inputting the data voltage Vdata to the first electrode of the driving transistor T1; the compensation transistor T3 is controlled to be turned on through the third scanning signal S3, transmitting the data voltage Vdata to the gate of the driving transistor T1. The first initialization transistor T8 is controlled to be turned off through the first scanning signal S1; the second initialization transistor T4 is controlled to be turned off through the second scanning signal S2. In FIG. 3, it is in an embodiment shown that the data writing transistor T2 is turned on when the fourth scanning signal S4 is at a low level.

In the third initialization phase t4, the compensation transistor T3 is controlled to be turned off through the third scanning signal S3, and the first initialization transistor T8 is controlled to be turned on through the first scanning signal S1, transmitting the third initialization voltage Vref3 to the second electrode and the first electrode of the driving transistor T1. The data writing transistor T2, the compensation transistor T3, and the second initialization transistor T4 are turned off.

FIG. 5 is a timing diagram of a holding frame of a pixel circuit provided by an embodiment of the present application. The holding frame comprises at least one holding emission phase. FIG. 5 in an embodiment shows that a holding frame F2 comprises two holding emission phases: a first holding emission phase t22 and a second holding emission phase t23. Before the holding emission phase, in a third initialization phase t21 of the holding frame, the resetting of the potential of the first electrode of the driving transistor T1 and the potential of the second electrode of the driving transistor T1 is also performed, so that a bias state of the driving transistor T1 in a data writing frame F1 does not differ greatly from a bias state of the driving transistor T1 in the holding frame F2, to improve the problem of a different brightness of the data writing frame F1 and the holding frame F2 during the low frequency driving, causing the low frequency low gray scale display problem.

Based on the above multiple embodiments, in one embodiment of the present application, please continue to refer to FIG. 3, the first initialization module 40 comprises a dual-gate transistor; that is, the first initialization transistor T8 is a dual-gate transistor. The dual-gate transistor comprises a first initialization sub-transistor and a second initialization sub-transistor.

A first electrode of the first initialization sub-transistor is electrically connected to a first initialization voltage terminal, a second electrode of the first initialization sub-transistor is electrically connected to a first electrode of the second initialization sub-transistor, a second electrode of the second initialization sub-transistor is electrically connected to the second terminal of the driving module 10. The second electrode of the second initialization sub-transistor is electrically connected to the second terminal of the driving module 10 and a first terminal of the compensation module 30. A gate of the first initialization sub-transistor and a gate of the second initialization sub-transistor are configured to receive the first scanning signal S1.

The dual-gate transistor may be a P-type transistor. The dual-gate transistor may be a polysilicon transistor. In an embodiment, a transistor included in the first initialization module 40 adopts a dual-gate design. When the dual-gate transistor is turned off, it is beneficial to completely turn off the dual-gate transistor, which may reduce a bright spot risk caused by a leakage of the first initialization module 40 or a positive bias of a threshold voltage Vth of the first initialization module 40.

In an embodiment, the first initialization module 40 comprises a first initialization transistor T8. A shielding layer is provided around a channel layer in the first initialization transistor T8 (in an embodiment, the shielding layer is located on a side of the channel layer of the first initialization transistor T8 away from a gate of the first initialization transistor T8), and the shielding layer is connected to a DC voltage VGH, which may reduce a probability of a bright spot caused by a positive bias of a threshold voltage Vth of the first initialization transistor T8, and is beneficial to improving a reliability of the first initialization transistor T8. The first initialization transistor T8 may also be a single transistor. In an embodiment, the DC voltage connected to the shielding layer may have a same logic as a turn-off level of the first initialization transistor T8. The first initialization transistor T8 may be a P-type transistor. The first initialization transistor T8 may be a polysilicon transistor. The DC voltage connected to the shielding layer may be a high voltage. The shielding layer may be electrically connected to a power line (configured to transmit the DC voltage VGH) of a scan driving circuit 100 and/or an emission control driving circuit 200 on the display panel.

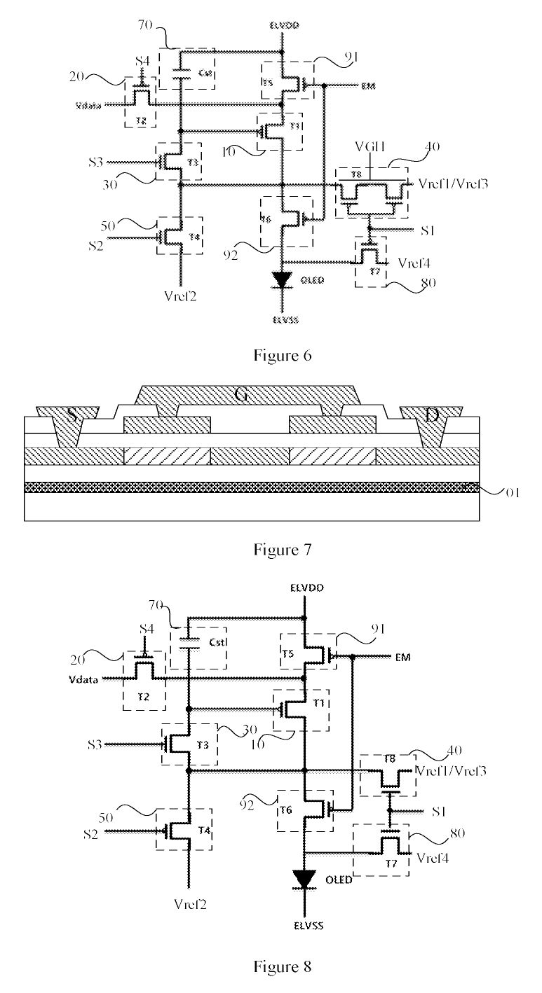

In an embodiment, FIG. 6 is a circuit diagram of another pixel circuit provided by an embodiment of the present application, and FIG. 7 is a cross-sectional view of a dual-gate transistor provided by an embodiment of the present application. Referring to FIGS. 6 and 7, the dual-gate transistor comprises a gate G, a first electrode, and a second electrode. The first electrode of the dual-gate transistor is a source S, and the second electrode is a drain D; or the first electrode is a drain D, and the second electrode is a source S. A shielding layer 01 is provided around a channel layer in the dual-gate transistor (in an embodiment, the shielding layer 01 is located on a side of the channel layer of the dual-gate transistor away from the gate of the dual-gate transistor), and the shielding layer 01 is connected to a direct current (DC) voltage VGH. The shielding layer 01 is provided around the channel layer of the dual-gate transistor, and the shielding layer 01 is connected to a DC voltage potential, which may reduce the probability of the bright spot caused by the positive bias of the threshold voltage Vth of the dual-gate transistor, and is beneficial to improving a reliability of the dual-gate transistor. The DC voltage connected to the shielding layer 01 may be a first power voltage. In an embodiment, the DC voltage connected to the shielding layer 01 may have the same logic as the turn-off level of the dual-gate transistor, in an embodiment, the DC voltage connected to the shielding layer 01 may be a high level. The shielding layer 01 may be electrically connected to a power line of a scan driving circuit 100 and/or an emission control driving circuit 200 on the display panel.

In another embodiment of the present application, FIG. 8 is a circuit diagram of another pixel circuit provided by an embodiment of the present application. Referring to FIG. 8, the first initialization module 40 comprises a first metal oxide transistor; that is, the first initialization transistor T8 is a metal oxide transistor. The first initialization transistor T8 may be an N-type transistor.

A first electrode of the first metal oxide transistor is electrically connected to a first initialization voltage terminal, and a second electrode of the first metal oxide transistor is electrically connected to the second terminal of the driving module 10. The second electrode of the first metal oxide transistor is electrically connected to the second terminal of the driving module 10 and a first terminal of the compensation module 30. A gate of the first metal oxide transistor is configured to receive the first scanning signal S1.

In an embodiment, the first initialization module 40 comprises a first metal oxide transistor. The metal oxide transistor may be an indium gallium zinc oxide (IGZO) Thin Film Transistor (TFT). The first initialization module 40 uses an IGZO transistor, which may reduce a bright spot problem caused by a leakage of the first initialization module 40.

In an embodiment, as shown in FIG. 8, the second initialization module 50 comprises a second initialization transistor T4, the second initialization transistor T4 is a polysilicon transistor, with a relatively small size, which is beneficial for a high pixel resolution (Pixels Per Inch (PPI)) setting. The second initialization transistor T4 may be a P-type transistor.

Based on the above multiple embodiments, in one embodiment of the present application, referring to FIGS. 3 and 6, the second initialization module 50 comprises a second metal oxide transistor; that is, the second initialization transistor T4 is a metal oxide transistor. The second initialization transistor T4 may be an N-type transistor.

A first electrode of the second metal oxide transistor is electrically connected to a second initialization voltage terminal; a second electrode of the second metal oxide transistor is electrically connected to the second terminal of the driving module 10. The second electrode of the second metal oxide transistor is electrically connected to the second terminal of the driving module 10 and a first terminal of the compensation module 30. A gate of the second metal oxide transistor is configured to receive a second scanning signal S2. It can be understood that the second initialization module 50 uses an IGZO transistor, which can improve the bright spot problem caused by a leakage of the second initialization module 50.

In an embodiment, referring to FIGS. 3, 6, and 8, the compensation module 30 comprises a third metal oxide transistor; that is, the compensation transistor T3 is a metal oxide transistor. The compensation transistor T3 may be an N-type transistor.

A first electrode of the third metal oxide transistor is electrically connected to the second terminal of the driving module 10 and a second terminal of the second initialization module 50; a second electrode of the third metal oxide transistor is electrically connected to the control terminal of the driving module 10; a gate of the third metal oxide transistor is configured to receive a third scanning signal S3. It can be understood that the compensation module 30 is directly electrically connected to the control terminal of the driving module 10, and the compensation module 30 uses an IGZO transistor, which can reduce or avoid a potential change at the control terminal of the driving module 10 caused by a leakage of the compensation module 30, thereby improving the display effect of the display panel.

Based on the above multiple embodiments, in one embodiment of the present application, please continue to refer to FIGS. 3, 6, and 8, the pixel circuit further comprises: a third initialization module 80, the third initialization module 80 is electrically connected to a first electrode (in an embodiment, an anode) of the light emitting device 60; the third initialization module 80 is configured to transmit a fourth initialization voltage Vref4 to the first electrode (in an embodiment, the anode) of the light emitting device 60 in at least one phase of the first initialization phase, a second initialization phase, and the third initialization phase. In an embodiment, the third initialization module 80 is configured to transmit the fourth initialization voltage Vref4 to the first electrode (in an embodiment, the anode) of the light emitting device 60 in the third initialization phase.

In an embodiment, a first terminal of the third initialization module 80 inputs the fourth initialization voltage Vref4, a second terminal of the third initialization module 80 is electrically connected to the first electrode (in an embodiment, the anode) of the light emitting device 60; by controlling a conduction state of the third initialization module 80, the fourth initialization voltage Vref4 can be transmitted to the first electrode (in an embodiment, the anode) of the light emitting device 60 in at least one phase of the first initialization phase, the second initialization phase, and the third initialization phase, to initialize a potential of the first electrode (in an embodiment, the anode) of the light emitting device 60, to control the light emitting device 60 not to emit light, and to clear a residual charge at the first electrode (in an embodiment, the anode) of the light emitting device 60. The third initialization module 80 comprises a third initialization transistor T7. The fourth initialization voltage Vref4 may be a negative voltage, in an embodiment, -4V.

In one embodiment of the present application, please continue to refer to FIGS. 3, 6, and 8, a control terminal of the third initialization module 80 and a control terminal of the first initialization module 40 receive a same scanning signal. In an embodiment, the control terminal of the third initialization module 80 and the control terminal of the first initialization module 40 are electrically connected to a same scan signal line. The third initialization module 80 and the first initialization module 40 may be turned on simultaneously, and turned off simultaneously. A channel type of a transistor in the third initialization module 80 and a channel type of a transistor in the first initialization module 40 may be the same.

In an embodiment, the control terminal of the third initialization module 80 and the control terminal of the first initialization module 40 receive the same scanning signal, which can reduce a number of scanning signals in the display panel, reduce a number of scan signal lines in the display panel, and reduce a difficulty of a wiring in the display panel. At this time, the third initialization module 80 can transmit the fourth initialization voltage Vref4 to the first electrode (in an embodiment, the anode) of the light emitting device 60 in the first initialization phase and the third initialization phase, to initialize the potential of the first electrode (in an embodiment, the anode) of the light emitting device 60.

In an embodiment, as shown in FIG. 8, the third initialization module 80 comprises a fourth metal oxide transistor, that is, the third initialization transistor T7 is a metal oxide transistor. The third initialization transistor T7 may be an N-type transistor.

A first electrode of the fourth metal oxide transistor is electrically connected to a third initialization voltage terminal, a second electrode of the fourth metal oxide transistor is electrically connected to the first electrode (in an embodiment, the anode) of the light emitting device 60; a gate of the fourth metal oxide transistor is configured to receive the first scanning signal S1. It can be understood that the third initialization module 80 uses an IGZO transistor, which can improve the bright spot problem caused by a leakage of the third initialization module 80.

In an embodiment, as shown in FIGS. 3 and 6, the third initialization module 80 comprises a third initialization transistor T7, the third initialization transistor T7 is a polysilicon transistor. The third initialization transistor T7 may be a P-type transistor.

Based on the above multiple embodiments, in one embodiment of the present application, please continue to refer to FIGS. 3, 6, and 8, the pixel circuit further comprises an emission control module. The emission control module, the driving module 10, and the light emitting device 60 are connected between a first power supply and a second power supply, the emission control module is configured to control a turn-on in an emission phase. One of the first power supply and the second power supply is a high voltage, and the other is a low voltage. The first power supply is configured to provide a first power voltage ELVDD, which may be a high voltage, and the second power supply is configured to provide a second power voltage ELVSS, which may be a low voltage.

Referring to FIG. 4, in the data writing frame F1, an emission phase t5 is further included after the third initialization phase t4. In the emission phase t5, the emission control module is controlled to be turned on, to enable the driving module 10 to generate a driving current to the light emitting device 60, to drive the light emitting device 60 to emit light. The emission control module may be turned off during the first initialization phase t1, the second initialization phase t2, the data writing phase t3, and the third initialization phase t4.

The emission control module may include a first emission control module 91 and/or a second emission control module 92, the first emission control module 91 is connected between the first power supply and the first terminal of the driving module 10. A control terminal of the first emission control module 91 is connected to an emission control signal EM.

The second emission control module 92 is connected between the second terminal of the driving module 10 and the first electrode (in an embodiment, the anode) of the light emitting device 60. A second electrode (in an embodiment, a cathode) of the light emitting device 60 is electrically connected to the second power supply. A control terminal of the second emission control module 92 is connected to the emission control signal EM.

The control terminal of the first emission control module 91 and the control terminal of the second emission control module 92 receive a same emission control signal EM. In one embodiment of the present application, the first emission control module 91 comprises a first emission control transistor T5, and the second emission control module 92 comprises a second emission control transistor T6. The emission phase t5 includes at least one emission sub-phase. FIG. 4 in an embodiment shows that the emission phase t5 includes a first emission sub-phase t51 and a second emission sub-phase t52. In the first emission sub-phase t51 and the second emission sub-phase t52, the first emission control transistor T5 and the second emission control transistor T6 are turned on.

The transistors used in all embodiments of the present application may be thin film transistors or field effect transistors or other devices with the same characteristics. In the embodiments of the present application, to distinguish two electrodes of a transistor other than a gate, one electrode is referred to as a first electrode, and another electrode is referred to as a second electrode. In an actual operation, when the transistor is a thin film transistor or a field effect transistor, the first electrode may be a drain, and the second electrode may be a source; or, the first electrode may be a source, and the second electrode may be a drain.

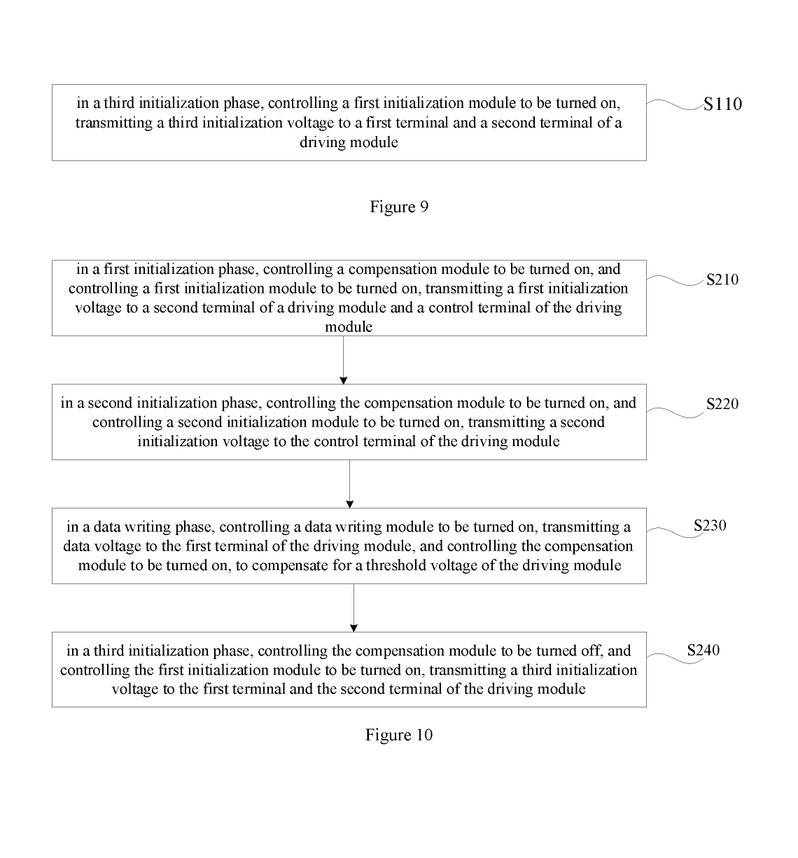

An embodiment of the present application further provides a driving method for a pixel circuit, applied to the pixel circuit of any embodiment of the present application. FIG. 9 is a flowchart of a driving method for a pixel circuit provided by an embodiment of the present application. Referring to FIG. 9, in combination with FIG. 1, the driving method for the pixel circuit includes following steps.

S110, in a third initialization phase, controlling a first initialization module to be turned on, transmitting a third initialization voltage to a first terminal and a second terminal of a driving module.

In an embodiment, in a data writing frame, the third initialization voltage is transmitted to the first terminal and the second terminal of the driving module through the first initialization module in the third initialization phase; such that a bias state of a driving transistor included in the driving module does not differ too much between the data writing frame and a holding frame, thereby improving a low frequency low gray scale flicker problem of a display panel and improving a display effect of the display panel.

FIG. 10 is a flowchart of another driving method for a pixel circuit provided by an embodiment of the present application. Referring to FIG. 10, in combination with FIG. 2, the driving method for a pixel circuit includes following steps.

S210, in a first initialization phase, controlling a compensation module to be turned on, and controlling a first initialization module to be turned on, transmitting a first initialization voltage to a second terminal of a driving module and a control terminal of the driving module.

In an embodiment, in a first initialization phase t1, a first initialization module 40 is controlled to be turned on, and a first initialization voltage Vref1 provided by a first initialization voltage terminal may be transmitted to a second terminal of a driving module 10; by cooperatively controlling a turn-on of a compensation module 30, the first initialization voltage Vref1 may be written to a control terminal of the driving module 10, to improve a hysteresis phenomenon of a driving transistor included in the driving module 10. In this phase, the driving module 10 is turned off.

S220, in a second initialization phase, controlling the compensation module to be turned on, and controlling a second initialization module to be turned on, transmitting a second initialization voltage to the control terminal of the driving module.

In an embodiment, in a second initialization phase t2, a second initialization module 50 and the compensation module 30 are turned on, transmitting a second initialization voltage Vref2 provided by a second initialization voltage terminal to the control terminal of the driving module 10, and initializing a potential of the control terminal of the driving module 10 through the second initialization voltage Vref2, to perform a writing of a data voltage in a data writing phase t3. In an embodiment, in the second initialization phase t2, the second initialization module 50 is controlled to be turned on, transmitting the second initialization voltage Vref2 to the second terminal and a first terminal of the driving module 10.

S230, in a data writing phase, controlling a data writing module to be turned on, transmitting a data voltage to the first terminal of the driving module, and controlling the compensation module to be turned on, to compensate for a threshold voltage of the driving module.

In an embodiment, in the data writing phase t3, the data writing module 20 and the compensation module 30 are controlled to be turned on, and at this time, under an action of the second initialization voltage Vref2, the driving module 10 may be in a conducting state, so that the data voltage Vdata provided by a data voltage terminal passes through the data writing module 20, the driving module 10, and the compensation module 30 in sequence, to charge the control terminal of the driving module 10 until the driving module 10 is turned off. At this time, a potential of the control terminal of the driving module 10 is Vdata+Vth, to perform a threshold voltage compensation, and Vth is a threshold voltage of a driving transistor included in the driving module 10. A driving circuit further comprises a storage module 70, the storage module 70 is connected to the control terminal of the driving module 10, the storage module 70 is configured to store a voltage of the control terminal of the driving module 10. The data writing module 20 is independently controlled, which can avoid sharing a control signal with other modules and affecting a compensation effect on the potential of the control terminal of the driving module 10, and can improve a display effect of a display panel.

S240, in a third initialization phase, controlling the compensation module to be turned off, and controlling the first initialization module to be turned on, transmitting a third initialization voltage to the first terminal and the second terminal of the driving module.

In an embodiment, in a third initialization phase t4, the first initialization module 40 is controlled to be turned on, and the compensation module 30 is controlled to be turned off. Through a cooperation of the first initialization module 40 and the driving module 10, a third initialization voltage Vref3 is input to the second terminal of the driving module 10 and the first terminal of the driving module 10. In this phase, the driving module 10 is turned on.

In a holding frame, before a holding emission phase, in a third initialization phase t21 of the holding frame, a resetting of a potential of the first terminal of the driving module 10 and a potential of the second terminal of the driving module 10 is also performed, so that a bias state of a driving transistor included in the driving module 10 in a data writing frame does not differ greatly from a bias state of the driving transistor included in the driving module 10 in the holding frame, to improve a problem of a different brightness of the data writing frame and the holding frame during a low frequency driving, causing a low frequency low gray scale display problem.

In an embodiment, referring to FIGS. 2, 6, and 8, the pixel circuit further comprises: a third initialization module 80, the third initialization module 80 is electrically connected to a first electrode (in an embodiment, an anode) of a light emitting device 60. The driving method for the pixel circuit further comprises controlling the third initialization module 80 to transmit a fourth initialization voltage Vref4 to the first electrode (in an embodiment, the anode) of the light emitting device 60 in at least one phase of a first initialization phase, a second initialization phase, and a third initialization phase.

In an embodiment, the fourth initialization voltage Vref4 is transmitted to the first electrode (in an embodiment, the anode) of the light emitting device 60, to initialize a potential of the first electrode (in an embodiment, the anode) of the light emitting device 60, to control the light emitting device 60 not to emit light, and to clear a residual charge at the first electrode (in an embodiment, the anode) of the light emitting device 60.

In an embodiment, the pixel circuit further comprises an emission control module; the emission control module, the driving module 10, and the light emitting device 60 are connected between a first power supply and a second power supply; after the third initialization phase of the data writing frame, and/or, after the third initialization phase of the holding frame, further including in an emission phase, controlling the emission control module to be turned on, to enable the driving module 10 to generate a driving current to the light emitting device 60, to drive the light emitting device 60 to emit light.

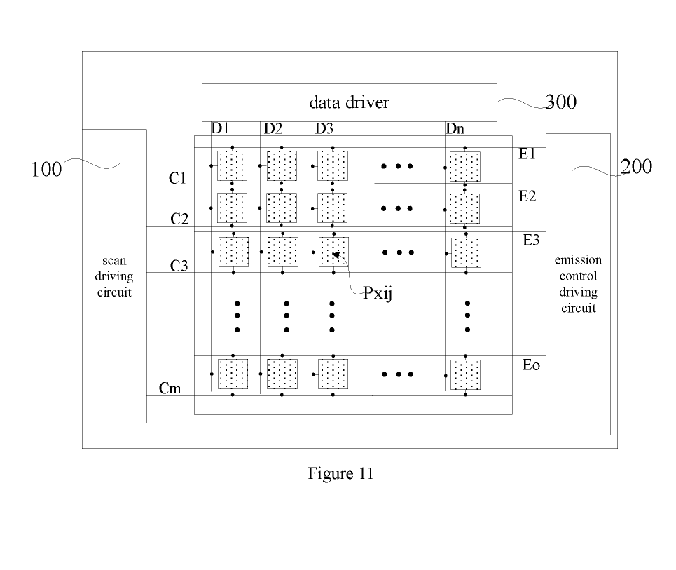

FIG. 11 is a structural diagram of a display panel provided by an embodiment of the present application. Referring to FIG. 11, an embodiment of the present application further provides a display panel, including the pixel circuit provided by any of the above embodiments.

The display panel comprises a scan driving circuit 100, an emission control driving circuit 200, and a driving chip as shown in FIG. 11. A display area comprises an array substrate and a light emitting device layer provided on the array substrate. The array substrate refers to a film layer structure that can provide a driving signal for the display panel and serve as a buffering, a protection, or a support function. The array substrate comprises a substrate and a driving circuit layer provided on the substrate. The driving circuit layer comprises a plurality of pixel circuit units, a plurality of data signal lines (D1 to Dn), a plurality of scan signal lines (C1 to Cm), a plurality of emission control signal lines (E1 to Eo), and a plurality of power lines. A data driver 300 is respectively connected to the plurality of data signal lines (D1 to Dn), the scan driving circuit 100 is respectively connected to the plurality of scan signal lines (C1 to Cm), and the emission control driving circuit 200 is respectively connected to the plurality of emission control signal lines (E1 to Eo).

The light emitting device layer comprises a plurality of light emitting devices, a circuit unit and a light emitting device connected to the circuit unit constitute a sub-pixel, the display area can include a plurality of sub-pixels Pxij, i and j can be natural numbers. The pixel circuit unit can at least include the pixel circuit provided by any of the above embodiments, the pixel circuit is respectively connected to a scan signal line, an emission control signal line, and a data signal line. The data signal line is configured to provide a data voltage to a pixel driving circuit, the scan signal line is configured to provide a scanning signal to the pixel circuit, and the emission control signal line is configured to provide an emission control signal to the pixel circuit, thereby achieving an emission control of the light emitting device.

What is claimed is:

1. A pixel circuit, comprising:
a driving module, having a first terminal and a second terminal,
a first initialization module, electrically connected to the second terminal of the driving module, and configured to transmit a third initialization voltage to the first terminal and the second terminal of the driving module in a third initialization phase; and
a light emitting device, connected between the second terminal of the driving module and a second power supply,
wherein the driving module is configured to generate a driving current to drive the light emitting device to emit light according to a voltage at a control terminal of the driving module.

2. The pixel circuit according to claim 1, wherein the first initialization module comprises a dual-gate transistor; the dual-gate transistor comprises a first initialization sub-transistor and a second initialization sub-transistor;
a first electrode of the first initialization sub-transistor is electrically connected to a first initialization voltage terminal, a second electrode of the first initialization sub-transistor is electrically connected to a first electrode of the second initialization sub-transistor, a second electrode of the second initialization sub-transistor is electrically connected to the second terminal of the driving module; a gate of the first initialization sub-transistor and a gate of the second initialization sub-transistor are configured to receive a first scanning signal.

3. The pixel circuit according to claim 2, wherein a shielding layer is provided around a channel layer in the dual-gate transistor, the shielding layer is connected to a direct current voltage.

4. The pixel circuit according to claim 3, wherein the shielding layer is connected to a first power voltage.

5. The pixel circuit according to claim 1, wherein the first initialization module comprises a first metal oxide transistor;
a first electrode of the first metal oxide transistor is electrically connected to a first initialization voltage terminal, a second electrode of the first metal oxide transistor is electrically connected to the second terminal of the driving module; a gate of the first metal oxide transistor is configured to receive a first scanning signal.

6. The pixel circuit according to claim 1, wherein the pixel circuit further comprises a data writing module, a compensation module, and a second initialization module;
the data writing module is electrically connected to the first terminal of the driving module; the compensation module is connected between the control terminal and the second terminal of the driving module; the second initialization module is electrically connected to the second terminal of the driving module;
the second initialization module is configured to transmit a second initialization voltage to the control terminal of the driving module through the compensation module in a second initialization phase;
the first initialization module is further configured to transmit a first initialization voltage to the second terminal of the driving module in a first initialization phase, and to transmit the first initialization voltage to the control terminal of the driving module through the compensation module;
the data writing module is configured to input a data voltage to the first terminal of the driving module in a data writing phase;
the compensation module is configured to perform a threshold voltage compensation on the driving module in a threshold compensation phase.

7. The pixel circuit according to claim 6, wherein the second initialization module is configured to transmit the second initialization voltage to the second terminal and the first terminal of the driving module in the second initialization phase.

8. The pixel circuit according to claim 6, wherein the first initialization voltage is the same as the third initialization voltage.

9. The pixel circuit according to claim 6, wherein the second initialization voltage is different from the third initialization voltage.

10. The pixel circuit according to claim 6, wherein
the second initialization module comprises a second metal oxide transistor;
a first electrode of the second metal oxide transistor is electrically connected to a second initialization voltage terminal; a second electrode of the second metal oxide transistor is electrically connected to the second terminal of the driving module; a gate of the second metal oxide transistor is configured to receive a second scanning signal;
the compensation module comprises a third metal oxide transistor;
a first electrode of the third metal oxide transistor is electrically connected to the second terminal of the driving module and a second terminal of the second initialization module; a second electrode of the third metal oxide transistor is electrically connected to the control terminal of the driving module; a gate of the third metal oxide transistor is configured to receive a third scanning signal.

11. The pixel circuit according to claim 1, wherein the pixel circuit further comprises:
a second emission control module, the second emission control module is connected between the second terminal of the driving module and a first electrode of the light emitting device, a second electrode of the light emitting device is electrically connected to the second power supply; a control terminal of the second emission control module is connected to an emission control signal;
a third initialization module, the third initialization module is electrically connected to the first electrode of the light emitting device; the third initialization module is configured to transmit a fourth initialization voltage to the first electrode of the light emitting device in the third initialization phase.

12. The pixel circuit according to claim 11, wherein a control terminal of the third initialization module and a control terminal of the first initialization module receive a same scanning signal.

13. The pixel circuit according to claim 12, wherein the third initialization module comprises a fourth metal oxide transistor; a first electrode of the fourth metal oxide transistor is electrically connected to a third initialization voltage terminal, a second electrode of the fourth metal oxide transistor is electrically connected to the first electrode of the light emitting device; a gate of the fourth metal oxide transistor is configured to receive a first scanning signal.

14. The pixel circuit according to claim 1, wherein a refresh period of the pixel circuit comprises a data writing frame and a holding frame, the data writing frame and the holding frame are both provided with the third initialization phase.

15. The pixel circuit according to claim 1, wherein the pixel circuit further comprises a first emission control module, the first emission control module is connected between a first power supply and the first terminal of the driving module, a control terminal of the first emission control module is connected to an emission control signal;
the pixel circuit further comprises a storage module, the storage module is connected between the control terminal of the driving module and the first power supply.

16. A driving method for a pixel circuit, applied to the pixel circuit according to claim 1,
the driving method comprising:
in a third initialization phase, controlling the first initialization module to be turned on, transmitting a third initialization voltage to the first terminal and the second terminal of the driving module.

17. The driving method for a pixel circuit according to claim 16, wherein the driving method further comprises:
in a first initialization phase, controlling a compensation module to be turned on, and controlling the first initialization module to be turned on, transmitting a first initialization voltage to the second terminal of the driving module and the control terminal of the driving module;
in a second initialization phase, controlling the compensation module to be turned on, and controlling a second initialization module to be turned on, transmitting a second initialization voltage to the control terminal of the driving module;
in a data writing phase, controlling a data writing module to be turned on, transmitting a data voltage to the first terminal of the driving module, and controlling the compensation module to be turned on, to compensate for a threshold voltage of the driving module.

18. The driving method for a pixel circuit according to claim 17, wherein in the third initialization phase, controlling the compensation module to be turned off, and controlling the first initialization module to be turned on, transmitting the third initialization voltage to the first terminal and the second terminal of the driving module.

19. The driving method for a pixel circuit according to claim 17, wherein
in the second initialization phase, controlling the second initialization module to be turned on, transmitting the second initialization voltage to the second terminal and the first terminal of the driving module;
the pixel circuit further comprises an emission control module; the emission control module, the driving module and the light emitting device are connected between a first power supply and a second power supply; the driving method further comprising:
in an emission phase, controlling the emission control module to be turned on, to enable the driving module to generate a driving current to the light emitting device, to drive the light emitting device to emit light.

20. A display panel, comprising the pixel circuit according to claim 1.
